(19) United States
(12) Patent Application Publication
(10) Pub. No.: US 2008/0256430 A1
(43) Pub. Date: Oct. 16, 2008

(54) AUTOMATED IMPLEMENTATION OF CHARACTERISTICS OF A NARRATIVE EVENT DEPICTION BASED ON HIGH LEVEL RULES

(75) Inventor: Josh Todd Gold, Newport Coast, CA (US)

Correspondence Address: Rutan & Tucker, LLP., 611 ANTON BLVD, SUITE 1400, COSTA MESA, CA, 92626, US

(73) Assignee: Clairvoyant Systems, Inc., Long Beach, CA (US)

(21) Appl. No.: 12/101,105

(22) Filed: Apr. 10, 2008

Related U.S. Application Data
(60) Provisional application No. 60/911,499, filed on Apr. 12, 2007.

(51) Int. Cl. G06F 17/00

(52) U.S. Cl. 715/200

(57) ABSTRACT

Systems and methods providing automated implementation of production characteristics for a narrative event, where a presentation criterion encoding the production characteristics is interpreted and selects a set of algorithms to use to implement those production characteristics, and where those algorithms implement the production characteristics for the event content representing the narrative event as a presentation criterion production collection and a presentation criterion integration specification, such that for an event depiction from the event content integrated with the presentation criterion production collection according to the presentation criterion integration specification, that event depiction reflects the production characteristics.

### CROSS REFERENCE TO RELATED APPLICATIONS

This application claims priority from U.S. provisional application Ser. No. 60/911,499 filed Apr. 12, 2007, which is hereby incorporated herein by reference in its entirety.

### FIELD OF THE INVENTION

This invention generally relates to the field of production of content for presentation devices. More particularly, the invention relates to a system and method for providing automated implementation of high level rule based depiction characteristics for the automated production of presentation content of a narrative event depiction, and to present these characteristics to an end user.

### DESCRIPTION OF THE RELATED ART

The depiction of a narrative event on presentation devices, such as a display device and a sound output device, requires production of content for those devices. Any such event can be so depicted in a multitude of different ways, or styles. The intended style of the resultant depiction can be represented as a set of production characteristics guiding the production process. The production process involves implementing those production characteristics so that the resulting presentation content reflects those production characteristics.

This application refers to, and utilizes systems and methods described in, U.S. patent application Ser. No. 11/676,922: “System and Method for the Production of Presentation Content Depicting a Real World”.

Existing visual real world event depiction production consists of the event capture using video cameras, and composing the presentation content from that event capture primarily by splicing together a sequence of cuts from the various cameras. The majority of visual non real world event depiction production is produced similarly, such as with the video camera capture of the performance of actors acting out the narrative event. Some limited production characteristics can be implemented with this production method, such as the number of cameras, their placement, and the direction of their view, but only before or during the event. Production characteristics implemented after the event typically consist of composing the sequence of cuts, visual and audio overlay, and adjusting brightness, contrast, color- and audio balance. The implementation of these production characteristics are performed either manually or under human supervision. Further, this production is done before the presentation content is distributed to the users of the content, and the user is unable to affect this production. This is the nature of an event depiction for distribution consisting of presentation content. The distributed content is not available to be further modified by other production characteristics, or at best, modified by relatively trivial production characteristics, such as video brightness or color contrast. The user is unable to implement any other production characteristic, such as those involving adding additional cameras, moving the camera to a different position or direction location, changing the lighting to reflect a different mood, changing the appearance of an object, and/or changing the focus and zoom of a camera. These aforementioned limitations are present regardless of whether presentation of the event is live or delayed, or whether the event is real or fictional.

### SUMMARY OF THE INVENTION

According to the present invention, production characteristics for the creation of presentation content relating to a depiction of a narrative event are automatically implemented by producer algorithms which utilize a set of high level rules or goals specifying those desired production characteristics. The automated producer may be utilized in the production of event content, in the creation of a production collection for use with event content, and/or for the creation/facilitation of presentation content. The automated producer may operate within the local presentation system of a user. Additionally, the automated producer may operate on a remote server in communication with a local presentation system of a user, or it may operate independently from user presentation systems. The automated producer may operate before, during, or both before and during the production of presentation content. Further, automated producer may adapt to changing conditions during its operation, including user or user interaction indicating new or modified production characteristics or manual control of production characteristics.

The automated producer operates under the direction of presentation criterions, which is the quantified representation of the production characteristics for which the automated producer is to implement in the resultant presentation content. The automated producer implements these presentation criterions by selecting or creating production material and production instructions used to control and supply the underlying presentation content production components. Each of these underlying components determine or produce some aspect of the presentation content. The automated producer may control or supply these components so that their operation produces presentation content conforming to the presentation criterions, or it may produce production collections whose prescribed use would result in the production of presentation content conforming to the presentation.

In an exemplary embodiment, the method for the automated implementation of at least one production characteristic for an event content for a narrative event the method comprising the steps of interpreting at least a production characteristic represented by a presentation criterion, wherein the interpretation of the production characteristic comprises the selection of at least an algorithm; and wherein the selection of the algorithm is based on the presentation criterion, implementing the production characteristic for an event content for a narrative event by utilizing said algorithm.

In an exemplary embodiment, the method includes production characteristic which is implemented for said event content by the operation of the algorithm referencing the event content to produce a presentation criterion production collection and a presentation criterion integration specification.

In an exemplary embodiment, a method includes automated implementation of at least one production characteristic for an event presentation of an event content for a narrative event, the method comprising the steps of providing at least one production characteristic which is encoded as a presentation criterion, and wherein said production characteristic is implemented for a first event content for a narrative event and wherein the production characteristic is the combination of a presentation criterion production collection and a presentation criterion integration specification; whereby the first event content is the event content of the combination and whereby the narrative event is the narrative event of the criterion production collection and the presentation criterion integration specification, wherein during presentation performance of an event presentation the presentation content production pipeline component receives a second event content instead of said first event content; and integrating the event content with the presentation criterion production collection according to the presentation criterion integration specification.

In an exemplary embodiment, a method where said second event content is produced during presentation operation of said event presentation.

In an exemplary embodiment, a method where said second event content is produced by control of the production collection input to the presentation content production pipeline component, where said control comprises the interception of said first event content portion of said production collection and replacing said portion with the corresponding portion of said second event content.

In an exemplary embodiment, where said production characteristic is implemented for said first event content during presentation operation.

In an exemplary embodiment, where said production characteristic is implemented for said first event content during presentation operation.

In an exemplary embodiment, a method for the automated production of a presentation collection for a narrative event from an event content for said narrative event, the method comprising steps of providing at least one first production characteristic that describes the aspects of the event depiction from an event content for a narrative event wherein said first production characteristic is encoded as at least one first presentation criterion providing a cumulative event content containing a plurality of event contents providing a presentation criterion production collection and a presentation criterion integration specification integrating the presentation criterion production collection in to said cumulative event content according to said presentation criterion integration specification whereby the resultant cumulative event content is integrated with each presentation criterion production collection, from the cumulative presentation criterion production collections according to the corresponding presentation criterion integration specification from said cumulative presentation criterion integration specifications.

In an exemplary embodiment, a method of the presentation collected for an event presentation of a narrative event is produced from an event content for said narrative event which is not a presentation collection.

In an exemplary embodiment, a method where a presentation collection is produced during presentation operation of said event presentation.

In an exemplary embodiment, a method comprising the steps of at least encoding one production characteristic as a presentation criterion, wherein the production characteristic is implemented for a second event content for a second narrative event and wherein the second narrative event comprises some portion of said first narrative event.

In an exemplary embodiment, a method of comprising a second event content comprises some first portion of the second event content, constructing a third event content by integrating the second event content with a second portion according to a third portion such that said third portion is the portion of said presentation criterion integration specification referring to said first portion, and such that said second portion is the portion of said presentation criterion production collection referred to by said third portion.

In an exemplary embodiment, a method comprising the step of encoding at least one production characteristic as a presentation criterion, and where said production characteristic is implemented for a second event content for a second narrative event such that said second narrative event comprises some first portion of said first narrative event and such that said second event content is input and where a third event content is constructed by integrating said second event content with said presentation criterion production collection according to said presentation criterion integration specification; and where said third event content is available as input.

In an exemplary embodiment, a method of production characteristics are selected by a user through the use of a human interface device.

In an exemplary embodiment, a method of production characteristics which are selected by a user through the use of a human interface device.

In an exemplary embodiment, a method for providing an algorithm, comprises determination of the temporal position, temporal duration, temporal rate, or temporal direction of the simulation, and further comprise the production of a production collection implementing said determination.

In an exemplary embodiment, a method for providing an algorithm which comprises determination of a sequence of one or more rendering operations, and further comprise the production of a production collection implementing said determination.

In an exemplary embodiment, a method where some or all of the rendering frustum is determined for each said rendering operation.

In an exemplary embodiment, a method where said algorithm comprises determination of a rendering model for a virtual world object for a rendering operation, such that said rendering model represents said virtual world object in said rendering.

In an exemplary embodiment, a method where said production characteristic comprises the first determination of a segment of the event depiction of said narrative event such that said segment is comprised of a simulation and a sequence of a plurality of renderings and such that said simulation is a for a single virtual world clock time span of said narrative event wherein the simulation progresses temporally sequentially from one bound of said virtual world clock time span to the other bound of virtual world clock time span and such that the difference between the rendering frustum of each first rendering of said sequence of renderings and the rendering frustum of the successive rendering, if any, is substantially similar to said difference from renderings adjacent to said first rendering, providing an algorithm that comprises one or both of a second determination of the temporal position, temporal duration, temporal rate, or temporal direction of said simulation and the production of a production collection implementing said second determination; and providing a third determination of the rendering operations for said sequence of renderings and the production of a production collection implementing said third determination.

In an exemplary embodiment, a method in the production characteristic comprises the determination of a rendering target for a sequence of renderings by a renderer such that said rendering target is the one or more representations of a corresponding one or more virtual world objects rendered by said renderer and such that each said representation is substantially or entirely contained within each said rendering and wherein the algorithm comprises the determination of said one or more virtual world objects.

In an exemplary embodiment, method claims where said production characteristic further comprises a constraint on the duration of the sequence of said segments in the event depiction of said narrative event and where said algorithm further comprises the determination of said sequence such that said duration is within said constraint.

In an exemplary embodiment, a method of the production characteristic comprises the determination of the language of each of one or more communications of the event depiction of said narrative event; and the algorithm comprises the determination of a presentation criterion production collection and a presentation criterion integration specification which implements each said language in each corresponding said communication, such that for each communication and for a corresponding one or more renderings from said event depiction of said communication, the representation of said communication in said renderings is expressed in said language.

In an exemplary embodiment, a method where one or more of said communications comprises the communication of a character of said narrative event, or where one or more of said communications comprise the communication of a narrator of said narrative event, or where at least one of said communications is in the form of written words.

In an exemplary embodiment, method further comprising the production characteristic which determines each of one or more narrations of the event depiction of said narrative event the algorithm comprises the determination of each said narration by selection of a narrative form from a group of narrative forms which correspond to a production characteristic translating a narration not already in the form of a production collection whereby the narrations produce a presentation criterion production collection presentation which implements the narrations.

In an exemplary embodiment, method of production characteristic comprises the determination of a musical accompaniment for each segment of the event depiction of the narrative event.

In an exemplary embodiment, method further comprising the steps of determination of an event depiction conforming to a suitability rating, such that said suitability rating specifies a measure of suitability of a depiction for a certain audience.

In an exemplary embodiment, the method where the suitability rating is based on the age of a member of the audience of said depiction and wherein the suitability rating is based on a measure of the amount within said depiction of one or more of sexual content, violent content, profanity, or drug or alcohol abuse.

According to one exemplary embodiment of the present invention, an automated producer implements a set of production characteristics in the presentation content of a narrative event. The underlying presentation content production component also operates on this system. Said presentation system is local to the presentation devices receiving the presentation content, and local to the users of the presentation, and may include the ability to elicit user input of the users. This user input may be used by end users to specify desired production characteristics of the presentation. These end user supplied production characteristics, represented as presentation criterions, control the production of presentation content, and therefore control the depiction of the narrative event.

According to another exemplary embodiment of the present invention, an automated producer operating remotely from the presentation system implements a set of production characteristics in the presentation content produced for a presentation of a narrative event. The remote automated producer communicates with the presentation system using a data communication means, such as an Internet connection. There may also be an automated producer operating on the presentation system, which may operate in collaboration with the remote automated producer. There may also be more than one remote automated producer. If there are a plurality of remote automated producers, the automated producers may operate in collaboration, in that rules may exist for resolving or preventing possible conflicting production characteristics received from two or more automated producers.

The use of the term “automated producer” herein should be understood to include all such automated producer embodiments, including, but not limited to: an automated producer operating on the presentation system, one or more automated producers operating remotely from the presentation system, and an automated producer which is a plurality of other automated producers.

The term “presentation system” is understood to include, but not limited, to any system for the production of presentation content. The automated producer functionality is involved with the production of presentation content and not with the transmission of that presentation content to presentation devices. Therefore the presence of that transmission of presentation content to presentation devices is not a required part of the present invention.

Further, in an exemplary embodiment, the automated producer functionality may be primarily involved with the production of one or more production collections. These production collections may be available for use by a presentation content production pipeline component for its production of presentation content. Therefore, according to another exemplary embodiment of the present invention, an automated producer operates to produce one or more production collections for use by a presentation content production pipeline component.

Due to the nature of the underlying presentation content production technology used by the present invention, is a wide array of production characteristics are implementable during presentation content production. Algorithmic implementation of these production characteristics offer many advantages over the existing manual only the implementation methods.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein may illustrate various embodiments of the invention from different viewing angles. Although the accompanying descriptive text may refer to such views as “top,” “bottom” or “side”-views, such references are merely descriptive and do not imply or require that the invention be implemented or used in a particular spatial orientation unless explicitly stated otherwise.

Various features, aspects, and embodiments of the inventions are described in conjunction with the attached drawings:

FIG. 1 is a schematic drawing illustrating an example of presentation content production related data flow prior to presentation performance, where operations involving the data flow result in the formation of a presentation collection.

FIG. 2 is a schematic drawing illustrating an example of presentation content production related data flow during presentation performance, where operations involving the data flow result in the formation of presentation content.

FIGS. 3A and 3B are schematic drawings illustrating an example of the primary steps involved in forming four custom presentation collections from four corresponding user presentation specifications and a single available production collection.

The figures are not intended to be exhaustive or limit the invention to the precise form disclosed. It should be understood that the invention may include, or be practiced with, modification and alteration, and that the invention be limited only by the claims and the equivalents thereof.

### DETAILED DESCRIPTION OF THE INVENTION

In the following paragraphs, the present invention will be described in detail by way of example with reference to the attached drawings. Throughout this description, any preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The use of certain terms herein relies on specific definitions. These terms and their corresponding definitions are listed in the Term Definitions table. The terms ‘user’ and ‘user’ are used interchangeably for one who views, observes, or is an audience member of, the presentation, or for one who uses the user input of the presentation system. The term ‘user’ commonly refers to visual observation, but herein refers to observation using any sense, not just the visual sense.

For illustrative purposes the narrative event used in descriptions of the present invention may be a specific type of narrative event in order to clarify the description. Descriptions in the present invention benefiting from this specific type of narrative event typically use the example of a motor sport race real world event. As would be appreciated by a person of ordinary skill in the art, the systems or methods described herein are applicable to, or may be modified to apply to, other narrative events without departing from the scope of the invention. Such other narrative events include, but are not limited to, other types of real world events, and non real world events, such as fictional events.

The motor sports race used herein as an example of specific narrative event which involves a plurality of participant vehicles traveling on a race track. The use of the term participant refers to both the human driver of the participant vehicle and the participant vehicle itself. Each participant is a member of a team, and a team may have more than one participant as members. In actual practice, additional elements of the real world event may be included, such as flag personnel or pit crew for the given motor sports example.

The present invention utilizes the functionality in a presentation content and a production pipeline component. In general, the steps for producing a presentation of a narrative event utilizing this functionality comprise of:

For a real world event, capturing the real world event as a set of real world measurements and converting the set of real world measurements based upon a virtual world values for use in the event content core. For a non real world event, produce an event content core for the narrative event. Producing one or more production collections for the narrative event, including the above event content core, sufficient to establish a presentation collection.
1) The one or more production collections sufficient to establish a presentation collection are transmitted to or established on the presentation system.
2) Presentation system prepares for presentation content production pipeline component operation.
3) Presentation system operates the presentation content production pipeline component, producing presentation content.
4) Presentation content is transmitted to the presentation devices.

Some parts of these operational steps may overlap in their operation, or may occur in a different order. Operation of elements of the present invention may occur within the presentation system or within a remote-system during preparation for presentation content production pipeline component operation or during the operation of the presentation content production pipeline component. Operation of elements of the present invention may also occur during the production collection, and at other times.

According to an exemplary embodiment the present invention, the depiction of a narrative event from event content may be partly or wholly determined by the operation of an automated producer. The nature of the presentation content production pipeline component process used by the present invention enables implementation of a wide variety of production characteristics. Production characteristics may be implemented during the event content production and supplied as part of the event content, so that each presentation, using only this event content and no automated producer, results in the same depiction. Production characteristics may also be implemented dynamically during the event presentation, so that each presentation reflects the production characters intended for that particular presentation. Production characteristics may be implemented as a production collection separate from a targeted event content, so that if the event content is integrated with the production collection according to instructions determined during the implementation of the production characteristics, then a resulting depiction would reflect those production characteristics.

Aspects of the depiction of the narrative event available to be determined, customized, or modified by the automated producer using the present invention include any aspect of the depiction which may be considered a production characteristic. The following is a brief description, for illustrative purposes only.

The automated producer may have broad control over many aspects of the shots that make up the presentation, including but not limited to camera placement, targeting, zoom, movement, and behavior, shot start and stop time, lighting, sound effects, models used for rendering, render algorithms used, shot order, narration, music, and presentation length. The automated producer may be given production characteristics which have different priorities, such as higher, than those the user specifies, such as production characteristics designed to highlight or feature advertiser, sponsor, or other content, so that regardless of the users supplied production characteristics, the higher priority production characteristics are implemented. This higher priority production characteristics feature may be a service which is purchased by those desiring this level of control of the depictions. Sufficiently sophisticated automated producer algorithms could have the ability to control and determine all aspects of the presentation from a minimal initial data set comprising the event content core. Sufficiently sophisticated automated producer algorithms could also have the ability to implement a depiction based on broad temperament categories, using algorithmic analysis of event content, to, for instance, produce a technically oriented depiction, or a dramatic depiction, or a human oriented depiction. Historical data representing user's preferences in production characteristics may be compiled, and that historical data may be referenced to automatically configure a presentation such that the depiction reflects that user's historical preferences. An example illustrating how these capabilities may be enabled is provided. During event content production, the various assets, including sub-events of significance occurring within the narrative event, may be tagged with a set of ratings or qualifiers, which may then be used by the automated producer to evaluate the import of those various assets.

The core of the automated producer functionality is to produce a presentation criterion production collection and a presentation criterion integration specification given a presentation criterion and a presentation criterion event content. This represents producing the means to implement one or more production characteristics in the event depiction of a narrative event. The presentation criterion represents the production characteristics to be implemented. The presentation criterion event content represents the narrative event. The presentation criterion production collection and a presentation criterion integration specification represent the means to implement the production characteristics. Therefore, for an event depiction from the presentation criterion event content integrated with the presentation criterion production collection according to the presentation criterion integration specification, that event depiction will reflect the production characteristics represented in the presentation criterion. The presentation criterion event content is a presentation collection, and the presentation criterion event content integrated with the presentation criterion production collection according to the presentation criterion integration specification be a presentation collection. For the above assertion that the event depiction will reflect the production characteristics, it is assumed that if the presentation criterion event content is not a presentation collection then it is supplemented with an additional production collection sufficient to produce a presentation collection, subject to the restriction that this additional production collection does not override any part of the presentation collection produced by the integration with the presentation criterion production collection. If any of this part is overridden by this additional production collection, then the production characteristics represented by those overridden parts reflected in the event depiction.

One embodiment of the present invention utilizes an automated producer in the production of event content for a narrative event. The automated producer produces one or more production collections, and those production collections are used in later stages of the event content production process. Another embodiment of the present invention utilizes an automated producer before, during, or both before and during an event presentation of a narrative event, where the automated producer implements production characteristics for that event presentation. The automated producer operates on the presentation system, and operate locally to the event presentation.

According to one embodiment of the present invention, an automated producer operating on a presentation system implements a set of production characteristics in the presentation content produced for a presentation of a narrative event. The underlying presentation content production component also operates on said presentation system. The presentation system is local to the presentation devices receiving the content, and sent local users of the presentation, and may include the ability to elicit user input of the end user. This end user input may be used by users to specify desired production characteristics of the presentation. These user supplied characteristics, represented as presentation criterions, control the production of presentation content, and therefore control the depiction of the narrative event.

During presentation content production for a presentation based on a set of production characteristics, these characteristics are ultimately expressed in the information that is supplied to the stages of the production process. This information is composed of two parts: production material and production instructions. Production material is the input supplied to each stage, which that stage then uses in producing its output. Production instructions control the operation of each stage, affecting its use of production material and therefore its resultant output. The function of the automated producer is to determine these production material and production instructions so that the presentation reflects the given production characteristics.

The production characteristics to be implemented by the automated producer are represented as presentation criterions for the automated producer. These presentation criterions may be arbitrarily high or low level, depending on the capabilities of the automated producer. An example of high level presentation criterion is one which creates a dramatic depiction of an event by analyzing the action and piecing the shots and cinematography together in a dramatic way. An example of less high level presentation criterion is one which uses a predefined set of production material and production instructions representing a particular depiction and modifies that set in order to make the presentation fit within a particular length of time. An example of a low level presentation criterion is one which sets the color of an object.

The production material and production instructions chosen by the automated producer to implement the production characteristics may be created by the automated producer or may be selected from a pool of resources available at the time of the operation of the automated producer. For an automated producer operating on a presentation system for an event presentation, this pool of available resources, available production collection, comprises the pool of available production material, or available production assets, the pool of available production instructions, and/or available production directives. The contents of this available production collection may determine in part limiting the production characteristics which the automated producer is able to implement, and may also determine in part the production characteristics choices available for user selection. For example, if the automated producer has the capability of creating a presentation of a specified length, but only by using the production material and production instructions from a pre-configured presentation, then such a pre-configured presentation typically must exist within the available production collection in order for this functionality of the automated producer to operate.

The functionality of the automated producer to implement production characteristics in a presentation of a narrative event is made possible by the functionality of the presentation content production pipeline component which produces the presentation content. This component comprises the operation of a series of production stages, each controlling a set of aspects of the final presentation content. Controlling the production material and production instructions supplied to each of these stages gives the automated producer highly detailed control over the resultant presentation content. For instance, the simulation stage, where a virtual world version of the event is generated, generally controls the start and stop times of each shot, the chronological direction and speed of the virtual world for each shot, and the sequence of shots. The rendering stage, where aspects of the simulation are converted into presentation device compatible forms, generally controls the form that those conversions take and where within the simulation those conversions are performed from. For the example of rendering for a display device, the rendering stage determines the placement and field of view of the rendering camera, and the rendered look of the virtual world objects within that field of view. The compositor stage combines the renderings with non-rendered material and composes the final form of the presentation content, for example, adding framing, narration, cut scenes, pre-rendered content, and explanatory content.

Specific examples of control over the presentation content, should be clear to any person of ordinary skill in the art that the specific examples given are illustrative, and should in no way restrict the scope of the present invention. For example, the automated producer determines that in order to implement a particular set of production characteristics it must create presentation content for a display device consisting of a particular view of the narrative event over a particular period of time of that event, and frame this view on one side of the display device, while placing textual information on the other side. Assuming the simulator already has access to simulator assets representing the narrative event, then simulator directives are created instructing the simulator to simulate the event over that particular period, which may be just one instruction telling what event time to start the simulation at and how long to continue the simulation. While this simulation is running the renderer is rendering visual images from the simulation. The renderer is supplied with rendering directives creating a virtual camera with the required characteristics and position within the simulation, and renderings are taken from that rendering camera. The compositor is supplied with compositor directives so that for each frame of the presentation content the renderings are positioning within a graphic frame on one side of the frame and the textual information, is displayed on the other side of the frame. The presentation content for the display device is now complete, and conforms to the original specifications for the content, and is ready to be sent to the display device for presentation.

Automated producer functionality encompassing shot creation determination, which in effect is the functionality that determines the shot specifics as given in the previous example, may be implemented in a variety of ways, and several examples. The automated producer implementing a production characteristic specifying a presentation less than the event length can determine what time periods of the event to include in the presentation by consulting a manually pre-configured table listing significant sub-events of the event, coded with various rankings based on different criteria. The automated producer includes shots with event time periods encompassing those sub-events which are of sufficiently high rank, based on some criteria, to fill the prescribed presentation length. For instance, for an auto race the event content production may create such a sub-event table, and one of the rankings may be ‘passing’, where each vehicle passing another vehicle sub-event is ranked according to their significance. The automated producer uses this table to produce a presentation of any length based on any of the available ranking criteria. A more sophisticated method of implementing this production characteristic is for the automated producer to analyze the narrative event directly, by either analyzing the event content or analyzing the simulation, and automatically detect and rank these sub-events.

For instance, for an auto race the automated producer would analyze the event content, detecting sub-events where one vehicle passes another, ranks these events by the relative race positions of the two vehicles and other criteria. Algorithms to place and characterize rendering cameras within each shot are similarly easily given. The field of view to show in a camera could be determined by ranking various interest criteria, and showing the view that encompasses the top ranking. For instance, interest criteria may include ‘passing’ and ‘leader’, where normally the leader criteria is of higher ranking than most passing sub-events, except where the pass is for a change in race position. This method would result in showing the leader except when there is a pass resulting in a change in race position, which would be shown instead of the leader. Emulating a traditional televised depiction of an auto race, several fixed rendering cameras could be positioned around the race track, and the nearest one to the area of focus chosen for rendering from. Alternately, a wide variety of other types of cameras never before possible with traditional real world event depictions are easily possible using the present invention, such as cameras that follow the vehicle from virtually any position relative to the vehicle. The camera type for any particular shot or part of a shot may be chosen specifically to highlight the sub-events of the shot. For instance, to highlight a passing sub-event, the rendering camera could be positioned behind and above the two vehicles in order to enhance the drama of the sub-event.

The present invention is further described in the diagrams.

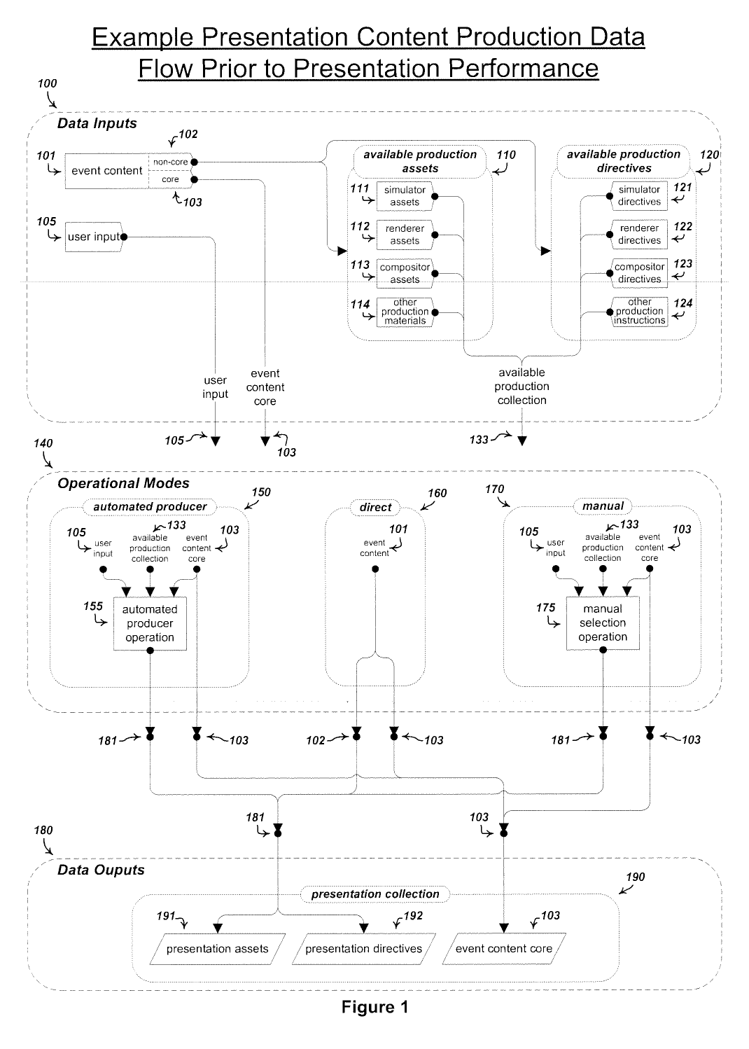

FIG. 1 illustrates a presentation content production related data flow prior to the presentation performance in an idealized embodiment of the present invention, where a narrative event has been selected for an event presentation, and the presentation initiation operation prepares for that presentation. The portion of the presentation initiation operation shown in the present figure is that which establishes the presentation collection. The operation inputs the event content core, available production collection, and user input, and produces as output a presentation collection for use in producing presentation content by the operation of the presentation performance. Three different operational modes are shown, including the operation of the automated producer according to one embodiment of the present invention, and two other operational modes for reference. These operational modes are not intended to be representative of every embodiment of the present invention, but rather as representative of only one possible embodiment.

Data inputs 100 consists of the inputs used in the operation to establish the presentation collection 190. Event content 101 comprises event content core 103 and may also include event content non-core 102. A single event content and event content core is shown for clarity, but the present invention is not limited to such use, and is applicable to presentations encompassing more than one event content and event content core. Event content is shown containing event content non-core for clarity, but the present invention does not require event content non-core. Event content non-core, if present, contributes to the available production assets 110 and available production directives 120. Available production assets consist of all the production materials available for establishing the presentation collection, comprising some combination of simulator assets 111, renderer assets 112, compositor assets 113, and other production materials 114. Available production directives consist of all the production instructions available for establishing the presentation collection, comprising some combination of simulator directives 121, renderer directives 122, compositor directives 123, and other production instructions 124. The combined available production assets and available production directives constitute the available production collection 133, which is the set of all production material and production instructions available for use in establishing the presentation collection. User input 105 uses one or more user input devices, such as a mouse or keyboard, for user or user selection of production characteristics. Production characteristics may also be selected in other ways, in combination with or instead of using user input, including, but not limited to, defined or inferred from saved preferences or history, from presentation criterions present in the available production collection, and from a remote system using a network for communication.

Operational modes 140 consists of three different modes of operation for establishing the presentation collection. The automated producer operational mode 150 inputs user input, the available production collection, and the event content core to the automated producer operation 155. The automated producer implements the specified production characteristics according to the available resources and outputs the resultant presentation collection. The automated producer operation may include the capability to create production material or production instructions which would be included in the presentation collection. The direct operation mode 160 uses the event content directly as the presentation collection. This is the default operation of a presentation operation which does not utilize an automated producer. The direct operational mode requires that the event content contain event content non-core sufficient to comprise the non event content core portion 181 of the presentation collection. The manual operational mode 170 inputs user input, the available production collection, and the event content core to the manual selection operation 175. This is a typical alternate mode of operation from the default direct operation mode of a presentation operation which does not utilize an automated producer. The user manually selects the presentation collection from the available production collection. The manual selection operation may include the capability to enable the user to create production material or production instructions which would be included in the presentation collection. Typically the user would initially be presented with a complete presentation collection, such as one already configured from the event content non-core as is required by the direct operational mode, and would then modify elements of this presentation collection, replace or add elements of this presentation collection with others from the available production collection.

Each of the three operational modes described output 180 a non event content core portion, consisting of presentation assets 191 and presentation directives 192, along with the event content core. These outputs comprise the presentation collection.

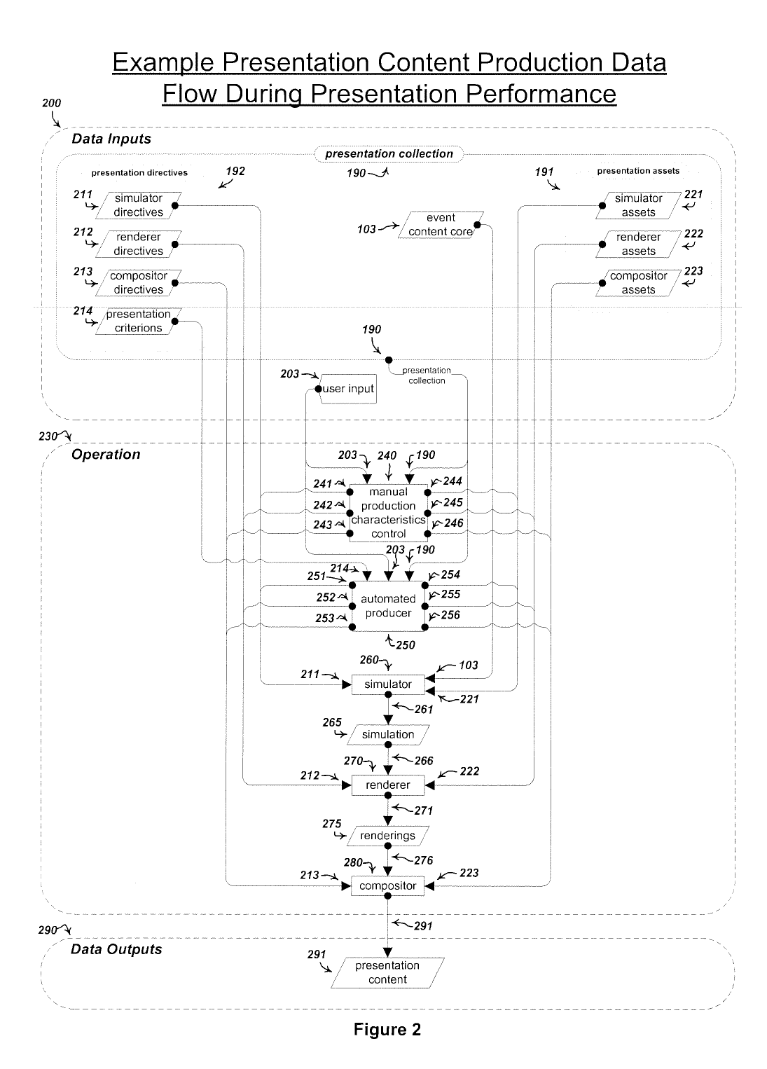

FIG. 2 illustrates presentation content production related data flow during the presentation performance in an idealized embodiment of the present invention, where a narrative event has been selected for an event presentation, and the presentation performance operation produces content for the presentation. The operation inputs the presentation collection and produces the presentation content as an output.

Data inputs 200 consists of the inputs used in the presentation content production operation. Outputs produced by stages of the presentation performance which are used as inputs by other stages of the presentation performance are not included here. The presentation collection 190 comprises event content core 103, presentation assets 191, and presentation directives 192. Presentation assets comprise simulator assets 221, renderer assets 222, compositor assets 223, and may include other production materials not shown. Presentation directives comprise simulator directives 211, renderer directives 212, compositor directives 213, and may include presentation criterions 214 and other production instructions not shown. User input 203 uses one or more user input devices, such as a mouse or keyboard, for user or user selection of production characteristics. Production characteristics may also be selected in other ways, in combination with or instead of using user input, including, but not limited to, defined or inferred from saved preferences or history, and from a remote system using a network for communication.

Operation of presentation content production process 230 comprises operation of the presentation content production pipeline component, the automated producer 250, and may include manual production characteristics control 240. The presentation content production pipeline component comprises one or more simulators 260, one or more renderers 270, and one or more compositors 280. A single simulator, renderer, and compositor is shown for clarity, but the operation is similar when a plurality of any is involved. Typically only a single simulator is used, because typically only a single simulation is needed to simulate the events depicted in the presentation content at any one moment, where the depiction at that moment is of a single moment within a single narrative event. Typically each presentation device type for which presentation content is being rendered requires a renderer. For instance, a depiction presented on a display device and a sound output device may require renderings made for both devices, so two renderers would operate, one converting the visual aspect of the simulation for the display device and the other converting the audible aspect of the simulation for the sound output device. For purposes of clarity herein, a plurality of simulators, a plurality of renderers, or a plurality of compositors are still considered to be a plurality of separate operational units even though they may be a single integrated software or algorithmic unit.

Each simulator, renderer, and compositor inputs production materials to construct their output, and inputs production instructions to control aspects of their operation. The simulator 260 inputs production materials in the form of simulator assets 221 and event content core 103 and inputs production instructions in the form of simulator directives 211. The output 261 of the simulator is the simulation 265. The renderer 270 inputs production materials in the form of the simulation 266 and renderer assets 222 and inputs production instructions in the form of renderer directives 212. The output 271 of the renderer is renderings 275. The compositor 280 inputs production materials in the form of renderings 276 and compositor assets 223 and inputs production instructions in the form of compositor directives 213. Data outputs 290 of the presentation content production process comprise the output of the compositor, which is presentation content 291.

The manual production characteristics control, if present, allows the user to alter various production characteristics during the presentation performance. The set of production characteristics alterable is determined by the functionality available within the manual production characteristics control during the presentation performance. The manual production characteristics control inputs the presentation collection and user input to perform its function, and may also if needed, but not shown, input production materials and production instructions output by the automated producer or by any other component of the presentation content production process as needed. Typical examples of manual production characteristics control include, but are not limited to, user control of camera position, viewing direction, and zoom, user control of event depiction chronological position, speed, and direction, commonly called playback position, speed, and direction, and may include control over many other aspects of the produced presentation content, including control over the apparent time of day, control of lighting, control of coloring of one or more objects, control of simulated weather, control of the number of simultaneous views of the event, control of individual sound effects, control of music or narration, and many other elements of control.

The automated producer provides automatic control of various production characteristics. The automated producer inputs the presentation collection to perform its function, and may also if needed, but not shown, input production materials and production instructions output by the manual production characteristics control or by any other component of the presentation content production process as needed. The automated producer may use user input for user modification of automated producer operation during the presentation performance. The automated producer also inputs presentation criterions, if present, which are production instructions controlling the operation of the automated producer.

Altering or controlling the produced presentation content during presentation performance requires altering one or both of the production materials and production instructions used by one or more of the simulator, renderer, and compositor. The manual production characteristics control and the automated producer both affect the produced presentation content using this method, therefore they each must have some control over one or both of the production materials and production instructions used by one or more of the simulator, renderer, and compositor. For the manual production characteristics control this comprises simulator assets control 244, renderer assets control 245, compositor assets control 246, simulator directives control 241, renderer directives control 242, and compositor directives control 243. For the automated producer this comprises simulator assets control 254, renderer assets control 255, compositor assets control 256, simulator directives control 251, renderer directives control 252, and compositor directives control 253. Although each of the manual production characteristics control and the automated producer is shown affecting some control over each of the production materials and production instructions of each of the simulator, renderer, and compositor, in actual practice some of these lines of control may be unnecessary, unimplemented, or missing for some other reason, and it is appreciated by those of ordinary skill in the art that these configurations are also within the scope of the present invention.

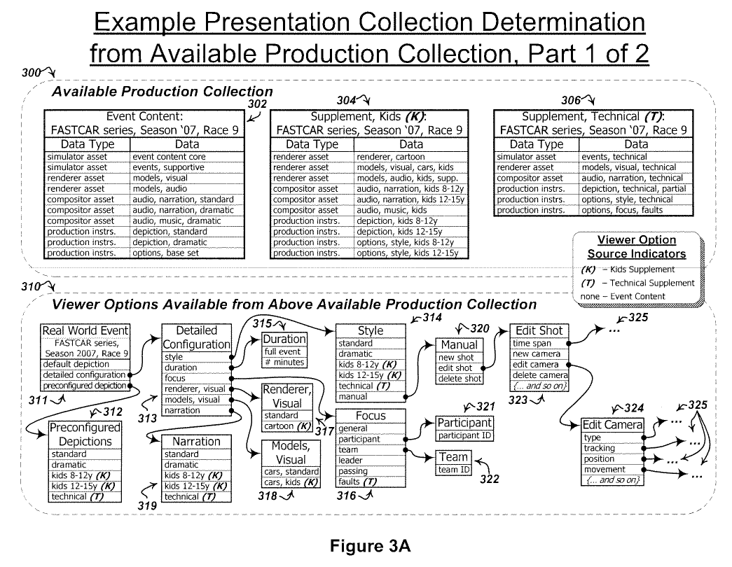

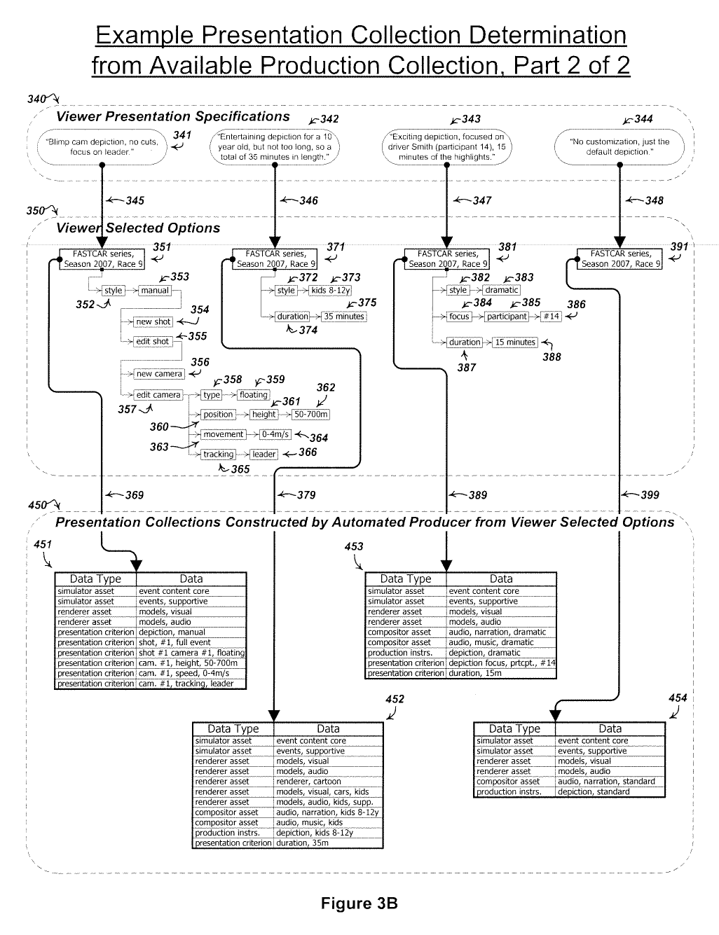

FIGS. 3A and 3B illustrates the primary steps involved in forming four custom presentation collections from four corresponding user presentation specifications and a single available production collection by an automated producer in an idealized embodiment of the present invention. The drawing illustrates examples of an available production collection, the set of user selectable production characteristics specification options formed from the available production collection by the automated producer, four different user presentation specifications, user's selected production characteristics specification options chosen to satisfy each of those four presentation specifications, and the presentation collections formed by the automated producer from each of those four selected production characteristics options for presentation on a display device and a sound output device.

The ability for the automated producer to generate many different depictions of a narrative event from a single set of source content data for that event is illustrated and depictions can be customized by the automated producer to the user's requirements. Each presentation collection, when used to produce presentation content during the presentation performance, produces a depiction of the same narrative event, although those depictions may have a different look or sound, or may be of different periods within the event. The particular narrative event in this example is an auto race, specifically race number 9 of the 2007 season of the FASTCAR series. In actual use of the present invention, the fictitious FASTCAR racing series may instead be an existing real world racing series. It is emphasized that even though the user customization shown is performed before the presentation performance, this is not meant to limit the user selection of customization options to this time period, and in practice many or all of these user customization options, or additional user customization options, may be available to the user during the presentation performance as well. This allows the user to customize the depiction during the presentation of that depiction, including, for instance, changing the depiction from standard to dramatic, or from kids 8 to 12 years old to kids 12 to 15 years old, or from the standard renderer to the cartoon renderer, or many other configuration changes.

The available production collection 300 consists of the event content 302, a kid's supplement 304, and a technical supplement 306. The event content and both supplements are all targeted to the aforementioned FASTCAR series season 2007 race 9 auto race. The event content consists of event content core, additional simulator assets for supportive events not captured as real world measurement based virtual world values, renderer assets consisting of rendering models for display devices and sound output-devices, compositor assets consisting of two different narrations and a musical score, production instructions consisting of two different pre-defined depictions, and additional production instructions enabling additional production characteristics specification options which may not already be available to the automated producer.

The kids supplement is available data set containing resources for producing a depiction tailored to children, specifically two different depictions for kids 8 to 12 years old, and kids 12 to 15 years old. The kids supplement consists of a renderer which renders the visual aspect of the simulation with a cartoon appearance, for use instead of the standard renderer which renders the visual aspect relatively photo realistically. Additional renderer assets consisting of display device rendering models for the race participant vehicles with an appearance or behaviors more interesting for children, such as cars with faces, and sound output device rendering models for kids oriented sound effects, compositor assets oriented toward kids consisting of two different narrations and a musical score, production instructions consisting of two different pre-defined depictions, and additional production instructions enabling additional production characteristics specification options which may not already be available to the automated producer are provided. The technical supplement is separately available data set containing resources for producing a depiction tailored to a user interested in the technical nature of the race. The technical supplement consists of additional simulator assets for supportive technical related events, such as detailed operational models of a vehicle engine, additional technical related rendering models for display devices, a compositor asset consisting of a technical narration, production instructions consisting of a technical related depiction supplements to the standard depiction, and additional production instructions enabling additional production characteristics specification options which may not already be available to the automated producer.

The set of user selectable production characteristics specification options 310 is formed by the automated producer from the available production collection, including additional options enabled by functionality present in the available production collection, and from option enabling functionality already present in the automated producer. All the options shown are derived from the available production collection in a straightforward manner. The source of the various options is indicated by the presence or absence of a symbol, where the italic and bold ‘(K)’ indicates that the option came from functionality present in the kids supplement, the italic and bold ‘(T)’ indicates that the option came from functionality present in the technical supplement, and the absence of a symbol indicates that the functionality came from either the event content or was already present in the automated producer. For ease of use, the user may be presented with reasonable default values for the options shown in order to minimize the amount of user input required to configure likely depictions. Therefore, the user need not go deeper into more detailed option menus unless the user desires to modify one or more of those more detailed values. As can be appreciated, many additional options and enhancements to this set of options, but for clarity of description of the present invention an exhaustive set of options is not shown in favor of the given more illustrative and uncluttered set of options. The options are organized in a tree structure, with nodes linked to other nodes, where a node contains a list of related options. The tree structure begins with a root node, and generally lower level nodes, or nodes more distantly linked to the root node, offer more detailed configuration options than higher level nodes along the same branch. These options presented to a user for their selection may be shown one node at a time, the method utilized in the description of this diagram, or may be shown in some other organizational manner.

The root node 311 for the real world event depiction of FASTCAR series season 2007 race 9 contains the three options typically appearing initially for any depiction using the present invention: default depiction, preconfigured depiction, and detailed configuration depiction. Selecting the default depiction option begins a standard or default depiction of the event as may be specified in the available production collection. This typically defaults depiction is the one shown when only the event content is available and no automated producer is in operation. Selecting the preconfigured depiction option may prompt with a list of the preconfigured depictions 312 which the automated producer found within the available production collection. The list includes the standard or default depiction, found within the event content, a dramatic depiction, also found within the event content, two different kids depictions targeted toward children of two different age groups, found within the kids supplement, and a technical depiction, found within the technical supplement. In the present example of a depiction of an auto race, the standard or default depiction may be one similar to a typical televised depiction of an auto race, and the dramatic depiction may be one in which the drama of the race is significantly enhanced using dramatic shot selection, including camera placements impossible to duplicate in the real world, dramatic music, dramatic narration, and other effects. Selecting the detailed configuration depiction option may prompt with a list of detailed configuration options 313. This set of options allows access to a broad array of configuration options, only a few of which are shown from the much greater set of those possible using the automated producer functionality of the present invention.

Style options 314 sets the depiction configuration to one of those selected preconfigured depictions, but does not begin the depiction, allowing for further detailed configuration. The options are the same as for preconfigured depictions 312, with an additional option allowing for manual configuration of shots. Duration options 315 allows for user specified depiction length, where the automated producer includes the more interesting or relevant events, based on some criteria of what is interesting or relevant, so that the depiction is of the specified duration. Typically when specifying a duration, that duration is less than the duration of the depiction where the duration was not specified by the user, as described here. A user specified duration greater than the duration of the depiction where the duration was not specified by the user may be implemented by the automated producer by repeating the most interesting or relevant events, for instance, from different camera angles or at slower speeds. The focus option 316 allows for user specified interest focus selection, where the depiction is formed with a focus on that selected by the user. Those shown include general focus, such as one appealing to a typical race fan; participant focus, where the focus is on a specified race participant; team focus, where the focus is on all the participants of a specified team; leader focus, where the focus is on the race leader; passing focus, where the focus is on passing incidents; and faults focus, where the focus is on racing faults like breakdowns, driver and team mistakes, equipment malfunctions, and accidents. The faults focus option is enabled through data or functionality found in the technical supplement. The visual renderer option 317 allows for the user to select the renderer to use for display devices. This option is available because more than one display device renderer is available. The default or standard renderer option typically balances between an effort to be photo realistic and the limitations imposed by the hardware and software capabilities. The cartoon render option is available because that renderer is included in the kids supplement. The visual models option 318 allows for the user to select the models to use for the rendering of the participant vehicles. This option is available because an additional set of participant vehicle models is available from the kids supplement. The standard cars option uses the models included in the event content for visual rendering, and such models would typically be realistic as possible subject to limitations as previously described. The kids cars option uses the models included in the kids supplement for visual rendering, and such models may, for instance, have eyes which respond to steering direction, and mouths and faces which respond the emotional content of the racing situation.

Note that the choice of visual renderer and visual models may be independent and may be selected in any configuration. The narration options 319 allows for the user to select the narration to use. The options include standard and dramatic, both from the event content, two different age appropriate narrations, both from the kids supplement, and a technical narration, from the technical supplement.

The manual style option selection prompts for manual configuration of shots 320. This may allow for detailed configuration of existing shots, such as those from preconfigured depiction, creation of wholly new shots, and deletion of shots. The edit shot option 323 allows for modification of the configuration of a particular shot, including editing the virtual world time span the shot encompasses, editing the camera parameters, creating or deleting a camera, and other options. The edit camera option 324 allows for editing various camera parameters, including the camera type, which may determine the shooting or cinematographic style, the camera tracking target, the camera position, camera movement parameters, and other options. The list of possible configuration options is extensive, and may continue for additional lower level nodes, as indicated by the ellipses 325.

Participant focus option selection prompts for user's selection of the participant ID 321, likely shown as a list of participant names or images. Team focus option selection prompts for user selection of the team ID 322, likely shown as a list of team names or images.

The example presentation specifications 340 are the users' casual descriptions of their desired depictions. Blimp cam presentation specification 341 describes a depiction typical from a blimp and minimally invasive, so that the entire event depiction consists of a single shot, always focused on the leader, from a camera drifting high above the ground. Kids presentation specification 342 describes a depiction oriented toward entertaining a 10 year old for 35 minutes. Driver Smith presentation specification 343 describes a dramatic depiction oriented toward a fan of a particular participant, in this case named Smith, and limited to only 15 minutes in length. Default presentation specification 344 is that depiction resulting from no customization, or the default depiction.

The user's selected production characteristics specification options 350, selected by the user from the set of user selectable production characteristics specification options 310, were selected by each user in order to configure the depiction to each user's presentation specification. The user's shown selected depiction configuration results in an equivalent set of production characteristics interpretable by the automated producer. Arrow path 345 indicates that the blimp cam presentation specification leads the user to select the options indicated for depiction configuration 351. Arrow path 346 indicates that the kids presentation specification leads the user to select the options indicated for depiction configuration 371. Arrow path 347 indicates that the driver Smith presentation specification leads the user to select the options indicated for depiction configuration 381. Arrow path 348 indicates that the default presentation specification, where the user selects no customization options, leads to depiction configuration 391. It is emphasized that even though all four depiction configurations are different, they all are depictions of the same FASTCAR series season 2007 race 9 real world event.

The blimp cam depiction configuration 351 is more extensive because no preconfigured depiction exists, so the user must construct the depiction from the options given. The user initially selects an empty or blank depiction, not shown, or removes all the shots from the existing configured depiction, also not shown. The user then selects the detailed configuration option, not shown, then the style option 352, then the manual style option 353, then creates a new shot by selecting new shot option 354. This new shot is then edited by selecting the edit shot option 355 and creating a camera by selecting the new camera option 356. The new camera is configured by selecting the edit camera option 357, then setting the camera type by selecting type 358 and selecting type floating 359, one of several types available for controlling the behavior of the camera. Some of these camera types, including the floating type, may utilize automated producer functionality to intelligently and automatically control the camera to implement that camera type's functionality. This automated producer camera control may include intelligent and automatic target determination and tracking, scene framing, and positioning. The particular camera type selected, floating, emulates the slow drifting movement of a floating object. Typically other camera types would be available, for example, a camera emulating a traditional televised broadcast fixed camera, an object mounted camera, cameras moving relative to an object in various ways, and other camera types. Limits on the height of the camera are configured by selecting position 360, then height 361, and selecting a range of 50 to 700 meters 362. The camera movement speed range is configured by selecting movement 363, then selecting a range of 0 to 4 meters per second. The tracking focus of the camera is configured by selecting tracking 365, then selecting the leader option 366.

The kids depiction configuration 371 begins with the user selecting the detailed configuration option, not shown, then the style option 372, then the kids 8 to 12 years old style option 373. The depiction duration is configured by selecting the duration option 374, then selecting 35 minutes 375.

The driver Smith depiction configuration 381 begins with the user selecting the detailed configuration option, not shown, then the style option 382, then the dramatic depiction option 383. The focus on driver Smith is configured by selecting the focus option 384, then the participant focus option 385, then selecting driver Smith, or participant 14 386. The depiction duration is configured by selecting the duration option 387, then selecting 15 minutes 388.

The default depiction configuration 391 is one in which the user performs no customization, so the user selects only the default depiction. (not shown)

The presentation collections 450 are formed from each of the four selected production characteristics options by operation of the automated producer. Arrow path 369 indicates that the blimp cam depiction production characteristics leads the automated producer to implement those production characteristics as presentation collection 451. Arrow path 379 indicates that the kids depiction production characteristics leads the automated producer to implement those production characteristics as presentation collection 452. Arrow path 389 indicates that the driver Smith depiction production characteristics leads the automated producer to implement those production characteristics as presentation collection 453. Arrow path 399 indicates that the default production characteristics leads the automated producer to implement those production characteristics as presentation collection 454.

The blimp cam depiction presentation collection 451 comprises simulator assets consisting of event content core and supportive events, renderer assets consisting of the standard visual and audio models, and presentation criterions, or production instructions for the automated producer during presentation performance, consisting of the user's single configured shot. From these presentation criterions, the automated producer produces the production materials and production instructions necessary to control the presentation content production pipeline component so that it produces presentation content reflecting the users selected production characteristics options. This is a straightforward process for the automated producer during the presentation performance, and is easily explained. The depiction consists of a single shot from the beginning to the end of the event, as defined in the presentation criterions, so the automated producer sends simulator directives to the simulator to start the simulation with the given simulator assets from the beginning of the event, and to continue to the end of the event. The automated producer creates a camera within the given height bounds, moving within the given speed bounds, tracking the race leader or the car in the pole position, positions this camera above the race track, and sends renderer directives and renderer assets to the renderer as required to implement this camera with the visual specifications of the attached display device. The audio portion of the presentation is handled similarly. In this case minimal compositing is required, so the automated producer sends compositor directives specifying that the renderings be sent directly to the display device and sound output device. During presentation performance the automated producer controls the camera as specified, perhaps moving it randomly within the event area and within the specified height and speed range, and tracking the race leader.

The kids depiction presentation collection 452 comprises simulator assets with an event content core and supportive events, renderer assets consisting of the standard visual and audio models. The presentation collection has cartoon renderer to use for rendering the visual presentation content, and car visual models and audio models superseding corresponding models in the standard visual and audio models, compositor assets consisting of narration and music, and presentation content production pipeline component production instructions for producing the preconfigured kids 8 to 12 years old depiction. Also included in the presentation collection is a presentation criterion instructing the automated producer to limit the presentation to 35 minutes. This automated producer operation, which determines which sections of the preconfigured depiction to use to produce a presentation of the specified length, may be performed entirely during presentation performance, or entirely before presentation performance by constructing an appropriate set of presentation content production pipeline component production instructions from the preconfigured depiction, or some combination of those two methods. Methods of performing this determination are straightforward, and are discussed elsewhere in this document. Ideally, whichever method is used, the user may have the option of instructing the automated producer to show more of a particular time frame of the event, even if that event time frame is not included in the automated producers chosen depicted event time frames.

The driver Smith depiction presentation collection 453 comprises simulator assets consisting of event content core and supportive events, renderer assets consisting of the standard visual and audio models, compositor assets consisting of narration and music, and presentation content production pipeline component production instructions for producing the preconfigured dramatic depiction. Also included in the presentation collection is a presentation criterion instructing the automated producer to limit the presentation to 15 minutes, and the process of implementing this is as explained above. An additional presentation criterion instructs the automated producer to override the standard camera control and instead use a participant focus target type, and to focus on participant 14, or driver Smith. This is readily performed during presentation performance using automated producer algorithms controlling camera parameters, and instructing the renderer to use those camera parameters, in the form of renderer assets and renderer directives, instead of the cameras defined in the preconfigured dramatic depiction. The result of this dynamic automated producer operation during presentation performance allows the user to change viewing position, to, for instance, zoom in closer to the action, or to change many or all of the other available production characteristic, and the presentation will continue on from that point properly implementing the new production characteristics.

The default presentation collection 454 comprises simulator assets consisting of event content core and supportive events, renderer assets consisting of the standard visual and audio models, compositor assets consisting of narration, and presentation content production pipeline component production instructions for producing the preconfigured standard depiction. No presentation criterions are included because no automated producer operation is necessary. This is the same presentation collection as that which would be used in the case of no automated producer present. During the depiction of this presentation, the automated producer may be available to implement user selected production characteristics, just as described previously for the other example depictions.

The specific described choices for systems, methods, components, mechanisms, functionality, and algorithms with respect to the preferred embodiment of the present invention is primarily for simplicity, and any practitioner of ordinary skill in the art can clearly see that alternate said choices could be substituted at any point without changing the scope or originality of the present invention.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to include the desired features of the present invention. Also, a multitude of different constituent module names other than those depicted herein may be applied to the various partitions. Additionally, with regard to flow diagrams, operational descriptions, and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may include applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional”, “traditional”, “normal”, “standard”, “known”, and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements, or components of the invention may be described or claimed in the singular, the plural is contemplated to be within the scope thereof unless limitation to the singular is explicitly stated.

The presence of broadening words and phrases such as “one or more”, “at least”, “but not limited to”, or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

Although the present invention has been described with several embodiments and examples, numerous changes, substitutions, variations, alterations, and modifications are possible, including those which should be obvious to one skilled in the art, and it is intended that the invention encompass all such changes, substitutions, variations, alterations, and modifications as fall within the spirit and scope of the included claims, descriptions, and drawings.

Automated Producer Patent Specific Term Definitions

| Term | Definition |
|---|---|
| rendering frustum | The region of space within the simulation from which a rendering is |
| | generated from. The exact shape of this region varies depending on |
| | the specifics of the rendering. For example, for a rendering for a |
| | display device it is the region of the simulation that may appear on |
| | the screen, commonly referred to as the field of view of the notional |
| | camera, and commonly the shape of this region varies depending on |
| | what kind of camera lens is being simulated, but typically it is a |
| | frustum of a rectangular pyramid. |
| production characteristic | A characteristic which determine the style with which an event |
| | depiction is presented. Differences in the expression of the |
| | characteristic do not change the history of the narrative event of said |
| | event depiction, where said history is originated from the event |
| | content core, but they do determine how said history is presented. |
| | Production characteristics may include, but are not limited to, the |
| | sequence of scenes with which each said narrative event is |
| | presented, characteristics for each camera and for each audio |
| | counterpart to a camera, such as position and movement path, |
| | artistic resources, such as lighting, music, and commentary, event |
| | element depictive resources, such as object models and sound |
| | effects, and sensory output device rendering style. |
| presentation criterion | One or more instructions specifying one or more production |
| | characteristics of an event depiction, where the interpretation and |
| | implementation of said instructions is performed by a presentation |
| | criterion implementation. |
| presentation criterion event | The event content which a presentation criterion is to be |
| content | implemented on. |
| presentation criterion | The production collection produced by the operation of a |
| production collection | presentation criterion implementation for a given presentation |
| | criterion and presentation criterion event content, where said |
| | production collection is for integration in to said presentation |
| | criterion event content in order to implement said presentation |
| | criterion. |
| presentation criterion | The acquired knowledge produced by the operation of a |
| integration specification | presentation criterion implementation for a given presentation |
| | criterion and presentation criterion event content, where said |
| | knowledge specifies the integration of the presentation criterion |
| | production collection produced by said presentation criterion |
| | implementation in to said presentation criterion event content in |
| | order to implement said presentation criterion. Note that this |
| | definition specifically implies that this acquired knowledge may or |
| | may not be available outside the automated producer functionality. |
| | This acquired knowledge may be partially or entirely retained |
| | within the operation of the automated producer, so that in such case |
| | such acquired knowledge is not output, or is only partially output, |
| | from the automated producer functionality. |
| presentation criterion | The process of interpreting and implementing a presentation |
| implementation | criterion on a presentation criterion event content, where operation |
| | of algorithms determined by said presentation criterion produce a |
| | presentation criterion production collection and corresponding |
| | presentation criterion integration specification, such that the event |
| | depiction from said presentation criterion event content integrated |
| | with said presentation criterion production collection according to |
| | said presentation criterion integration specification has the |
| | production characteristics specified by said presentation criterion. |
| automated producer | The operation of presentation criterion implementation for one or |
| | more presentation criterions. |

General Term Definitions

| Term | Definition |
|---|---|
| subset | A set whose members are all members of some other set, including |
| | the case where all the members of said other set are also members |
| | of said set. |
| package | An entirely or substantially pre-assembled unit, which is transmitted |
| | by the package supplier entirely or substantially unchanged to each |
| | package receiver. |
| DRM | digital rights management |
| event depiction | The representation of a narrative event from the event content core |
| | for said narrative event. |
| event presentation | The event depiction presented on presentation devices supplied with |
| | presentation content by presentation content production. |
| presentation specification | A description of the desired event depiction resulting from an event |
| | presentation. |
| event content producer | The functionality whose operation results in the production of event |
| | content for a narrative event. |
| event content distributer | The functionality whose operation results in the distribution of |
| | event content from the event content producer to an event content |
| | visualizer. |
| event content visualizer | The functionality whose operation results in an event presentation. |
| presentation device | A device whose purpose includes producing sensory output |
| | detectable by at least one sense. Said device is connected to one or |
| | more sources of content for said device by a communication means, |
| | and produces said sensory output depending on said content. |
| | Examples of such a device include, but are not limited to, a visual |
| | sensory output device, or display device, such as a television or |
| | monitor, and an audible sensory output device, or sound output |
| | device, such as a stereo or surround sound system. |
| human interface device | A device which interacts directly with a human user to take input |
| | from said user and enable said input to be transmitted to a computer |
| | in digital form. Examples include, but are not limited to, a mouse, |
| | keyboard, or joystick. Example uses include, but are not limited to, |
| | enabling said user to input data, indicate intentions, convey interest, |
| | or specify a selection. |
| local system | The interconnected devices local to the viewing area of an event |
| | presentation, where said devices host the local functionality portion |
| | of said event presentation, comprising a presentation system, one or |
| | more presentation devices, and may include one or more human |
| | interface devices. |

Presentation Content Production Data Related Term Definitions

| Term | Definition |
|---|---|
| presentation content | Content in an encoding suitable for input to one or more |
| | presentation devices. |
| production material | One or more resources for use as input to one or more processes of |
| | the presentation content production, for use by said processes in the |
| | production of output resulting from that process. |
| production instruction | One or more rules specifying, controlling, or defining how |
| | production material is used in the operation of one or more |
| | processes of the presentation content production. |
| production collection | One or both of one or more production materials and one or more |
| | production instructions. |
| simulation | A virtual three dimensional reality generated by algorithms |
| | operating on one or more computational devices. A common |
| | example of a simulation is in a video game, where a virtual world is |
| | generated as a simulation by a computer. |
| rendering | The resultant output from an operation of a renderer. |
| simulator asset | Production material for use by a simulator. Simulator assets |
| | include, but are not limited to, a virtual world object, and data or |
| | algorithms for controlling aspects of said virtual world object. |
| renderer asset | Production material for use by a renderer. A simulation is a |
| | renderer asset. Renderer assets also include, but are not limited to, a |
| | model to use for a virtual world object for the rendering of that |
| | object. |
| compositor asset | Production material for use by a presentation content compositor. A |
| | rendering is a compositor asset. Compositor assets also include, but |
| | are not limited to, production material for use in overlaying, |
| | underlying, or replacing renderings, such as overlaying textual |
| | information or replacing videos for a display device, or overlaying |
| | narration or underlying music for a sound output device. |
| simulator directive | Production instruction for use by a simulator. Simulator directives |
| | include, but are not limited to, control of the simulation temporal |
| | position, rate, or direction. |
| renderer directive | Production instruction for use by a renderer. Renderer directives |
| | include, but are not limited to, control of which model to use for the |
| | rendering of a virtual world object, and the position and direction |
| | within the simulation from which a rendering is generated. |
| compositor directive | Production instruction for use by a presentation content |
| | compositor. Compositor directives include, but are not limited to, |
| | control of the content selected for overlaying, underlying, or |
| | replacing renderings, and control of the placement of renderings |
| | within the presentation content. |
| available production assets | The available production materials which may be used by a |
| | presentation content production. Available production assets may |
| | include simulator assets, renderer assets, and compositor assets, and |
| | may also include other production material as needed or available. |
| available production | The available production instructions which may be used by a |
| directives | presentation content production. Available production directives |
| | may include simulator directives, renderer directives, and |
| | compositor directives, and may also include other production |
| | instructions as needed or available. |
| available production | The available production assets and available production directives |
| collection | for a given presentation content production. |
| presentation collection | Event content core and a subset of the available production |
| | collection sufficient to enable the production of presentation content |
| | by presentation content production. |
| presentation assets | The subset of the available production assets used for the |
| | production materials portion of a presentation collection. |
| presentation directives | The subset of the available production directives used for the |
| | production instructions portion of a presentation collection. |

Presentation Content Production Functionality Related Term Definitions

| Term | Definition |
|---|---|
| presentation operation | The operation of an event presentation, or The operation of |
| | producing presentation content by presentation content production. |
| presentation initiation | The portion of the presentation operation where elements necessary |
| | for the presentation performance are made ready. |
| presentation performance | The portion of the presentation operation where the event depiction |
| | is presented on the presentation devices, or the portion of the |
| | presentation operation where the presentation content is produced. |
| presentation termination | The portion of the presentation operation occurring after the |
| | presentation performance. |
| simulator | The process of operating a simulation. |
| renderer | The process of converting an aspect of a simulation into a form |
| | compatible with a presentation device of a given type and |
| | capability. A typical render operation may be the conversion of the |
| | view from a given position in a given direction within a simulation |
| | to a form suitable for transmission to a display device, or the |
| | conversion of the soundscape from a given position in a given |
| | direction within a simulation to a form suitable for transmission to a |
| | sound output device. |
| compositor | The process of composing presentation content from one or both of |
| | one or more renderings and other production material. |
| presentation content | The functionality of the portion of the presentation operation |
| production pipeline | producing presentation content from a presentation collection, |
| component | where production characteristics are determined by the production |
| | material and production instructions supplied to said functionality, |
| | said functionality comprising functionality for the operation of: |
| | one or more simulators, controlled by simulator directives, using |
| | simulator assets, and producing one or more simulations; |
| | one or more renderers, controlled by renderer directives, using |
| | said one or more simulations and other renderer assets, and |
| | producing renderings; |
| | one or more presentation content compositors, controlled by |
| | compositor directives, using said renderings and other |
| | compositor assets, and producing presentation content. |
| presentation content | The operation of the presentation content production pipeline |
| production pipeline | component. |
| presentation content | The operation of producing presentation content, comprising the |
| production | presentation content production pipeline. |
| presentation system | The system generating an event presentation, including operating |
| | the presentation operation and transmitting presentation content to |
| | the presentation devices. |

Real World Event Depiction Related Term Definitions

| Term | Definition |
|---|---|
| real world clock time span | A span of clock time, bound by a start clock time and an end clock |
| | time, where said span is formed from a measurement of real world |
| | time, a duration of real world time, and an offset of real world time, |
| | such that said start clock time is equal to the sum of said |
| | measurement and said offset, and such that said end clock time is |
| | equal to the sum of said measurement, said offset, and said duration, |
| | and where said offset is either implicit or is explicitly measured, and |
| | where said duration is either implicit or is explicitly measured, and |
| | where said start clock time and said end clock time implicitly, |
| | explicitly, or effectively share a common time scale. Examples |
| | include, but are not limited to, May 16, 2006 1:45 PM to May 16, 2006 |
| | 3:00 PM local time, and May 16, 2006 05:47:32.843 UTC with an |
| | implicit error range of plus or minus 4 milliseconds. Examples of |
| | said time scale include, but are not limited to, Greenwich Mean |
| | Time, Coordinated Universal Time, the local time scale of some |
| | time zone, or some time scale based on one or more clocks. |
| real world object | A physical object in the real world. Examples include, but are not |
| | limited to, a solid, liquid, or gas body, or some collection of said |
| | bodies, such as a car, a person, the surface of an area of land, a road, |
| | a body of water, and a volume of air above an area of land. |
| real world measurable | A measurable quality of a real world object. Examples include, but |
| quality | are not limited to, size, mass, location, direction, velocity, |
| | acceleration, pressure, temperature, electric field, magnetic field, |
| | and many other physical properties of a real world object. |
| real world measurement | The value of a measurement of a real world quality of a real world |
| | object over a real world clock time span, or a composite |
| | measurement from a plurality of measurements of a real world |
| | quality of a real world object over a real world clock time span, |
| | where the value of said composite measurement and the |
| | corresponding real world clock time span of said composite |
| | measurement are calculated using interpolation, extrapolation, curve |
| | fitting, averaging, or some other algorithm, from said plurality of |
| | measurements. Examples include, but are not limited to, |
| | measurement of the location of a particular vehicle at a particular |
| | time, or a plurality of such measurements for said vehicle over a |
| | time span, and interpolating between said measurements using said |
| | time span to calculate said vehicle position at a particular time |
| | within said time span. Example uses of composite measurements |
| | include, but are not limited to, obtaining a likely measurement at a |
| | time when no measurement was actually made, such as at a time |
| | between two measurements, or to increase the accuracy of a |
| | measurement by averaging a plurality of measurements, or to |
| | increase or decrease the rate of measurements to a desired rate. For |
| | instance, a measurement of position of an object made at a rate of |
| | 75 times per second may be reduced to a measurement rate of 60 |
| | times per second. |
| real world event | A real world clock time span and a set of one or more real world |
| | objects, where for each said real world object there is set of real |
| | world measurements, where the real world clock time span for each |
| | said real world measurement is within said real world clock time |
| | span of the real world event. Examples include a motor sports |
| | event, where the position of the participating vehicles are measured |
| | at regular intervals during the duration of the event, or a sail boat |
| | race, where the position, hull speed, and air speed and direction of |
| | the participating boats, and the water current speed and direction at |
| | a set of fixed locations, and the air speed and direction at a set of |
| | fixed locations, are all measured at regular intervals during the |
| | duration of the event. |
| real world measurement | The virtual world value of a virtual world quality of a virtual world |
| based virtual world value | object over a virtual world clock time span, where said virtual world |
| | value reflects a real world measurement, and where said virtual |
| | world measurable quality corresponds to the real world quality of |
| | said real world measurement, and where said virtual world object |
| | corresponds to the real world object of said real world |
| | measurement, and where said virtual world clock time span |
| | corresponds to the real world clock time span of said real world |
| | measurement. |

Depiction of a Narrative Event Other Than a Real World
Event Related Term Definitions

| Term | Definition |
|---|---|
| non real world event | A narrative event which does not meet the |
| | definition of a real world event. Examples include a |
| | real world narrative event which is not represented |
| | by real world measurements, or a fictional narrative |
| | event. |

Event Content and Corresponding Virtual World Related Term Definitions

| Term | Definition |
|---|---|
| virtual world clock time | A span of virtual clock time, bound by a start virtual clock time and |
| span | an end virtual clock time, within the virtual three dimensional |
| | reality of a simulation. The virtual three dimensional reality |
| | equivalent to the definition of real world clock time span for the real |
| | world. Examples include, but are not limited to, a representation |
| | within a simulation of a real world clock time span. |
| virtual world object | A virtual physical object within the virtual three dimensional reality |
| | of a simulation. The virtual three dimensional reality equivalent to |
| | the definition of real world object for the real world. Examples |
| | include, but are not limited to, a representation within a simulation |
| | of a real world object, such as a race track, a vehicle, a body of |
| | water, a building or other structure, the surface features of an area |
| | of land, or a volume of air, or a version of any of those example |
| | objects which are not real world objects. |
| virtual world measurable | A virtual measurable quality of a virtual world object. The virtual |
| quality | three dimensional reality equivalent to the definition of real world |
| | measurable quality for the real world. Examples include, but are |
| | not limited to, a representation within a simulation of a real world |
| | measurable quality. |
| narrative event | A message that tells the particulars of an act or occurrence or course |
| | of events, or the telling of a story, consisting of a real world event |
| | or a non real world event, where said message is not dependent on |
| | interaction of a user of a presentation of said message for |
| | determination of said message, such as user game play, where a |
| | video game in particular is excluded as a narrative event. |
| event content | A production collection which represents a narrative event and is |
| | for use by presentation content production to produce presentation |
| | content depicting the narrative event, comprising event content core |
| | for the narrative event, if any, and event content non-core, if any. |
| event content core | The portion of the event content for a narrative event whose use in |
| | unchanged form in presentation content production is required in |
| | order for the depiction resulting from said production to be an |
| | accurate representation of the narrative event, where for a narrative |
| | event which is a real world event said portion of the event content |
| | comprises the set of real world measurement based virtual world |
| | values for each real world object from said real world event. |
| event content non-core | The portion, if any, of the event content which is not event content |
| | core. |

What is claimed is:

1. A method for the automated implementation of at least one production characteristic for an event content for a narrative event the method comprising the steps of:
interpreting at least a production characteristic represented by a presentation criterion,
wherein the interpretation of the production characteristic comprises the selection of at least an algorithm; and
wherein the selection of the algorithm is based on the presentation criterion, implementing the production characteristic for an event content for a narrative event by utilizing said algorithm.

2. The method of claim 1 where said production characteristic is implemented for said event content by the operation of the algorithm referencing the event content to produce a presentation criterion production collection and a presentation criterion integration specification.

3. A method for the automated implementation of at least one production characteristic for an event presentation of an event content for a narrative event, the method comprising the steps of:
providing at least one production characteristic which is encoded as a presentation criterion, and wherein said production characteristic is implemented for a first event content for a narrative event and wherein the production characteristic is the combination of a presentation criterion production collection and a presentation criterion integration specification;
whereby the first event content is the event content of the combination and whereby the narrative event is the narrative event of the criterion production collection and the presentation criterion integration specification;
wherein during presentation performance of an event presentation the presentation content production pipeline component receives a second event content instead of said first event content; and
integrating the event content with the presentation criterion production collection according to the presentation criterion integration specification.

4. The method of claim 3, where said second event content is produced during presentation operation of said event presentation.

5. The method of claim 4, where said second event content is produced by control of the production collection input to the presentation content production pipeline component, where said control comprises the interception of said first event content portion of said production collection and replacing said portion with the corresponding portion of said second event content.

6. The method of claim 3, where said production characteristic is implemented for said first event content during presentation operation.

7. The method of claim 5, where said production characteristic is implemented for said first event content during presentation operation.

8. A method for the automated production of a presentation collection for a narrative event from an event content for said narrative event, the method comprising the steps of:
providing at least one first production characteristic that describes the aspects of the event depiction from an event content for a narrative event wherein said first production characteristic is encoded as at least one first presentation criterion;
providing a cumulative event content containing a plurality of event contents;
providing a presentation criterion production collection and a presentation criterion integration specification;
integrating the presentation criterion production collection in to said cumulative event content according to said presentation criterion integration specification whereby the resultant cumulative event content is integrated with each presentation criterion production collection, from the cumulative presentation criterion production collections according to the corresponding presentation criterion integration specification from said cumulative presentation criterion integration specifications.

9. The method of claim 8, further comprising the steps of:
the presentation collection for an event presentation of a narrative event is produced from an event content for said narrative event which is not a presentation collection.

10. The method of claim 8, where said presentation collection is produced during presentation operation of said event presentation.

11. The method of claim 2, the method further comprising the step of:
at least encoding one production characteristic as a presentation criterion, wherein the production characteristic is implemented for a second event content for a second narrative event and wherein the second narrative event comprises some portion of said first narrative event.

12. The method of claim 11, further comprising the step of:
the second event content comprises some first portion of the second event content;
constructing a third event content by integrating the second event content with a second portion according to a third portion such that said third portion is the portion of said presentation criterion integration specification referring to said first portion,
and such that said second portion is the portion of said presentation criterion production collection referred to by said third portion.

13. The method of claim 2, the method comprising the step of:
encoding at least one production characteristic as a presentation criterion, and where said production characteristic is implemented for a second event content for a second narrative event such that said second narrative event comprises some first portion of said first narrative event and such that said second event content is input;
and where a third event content is constructed by integrating said second event content with said presentation criterion production collection according to said presentation criterion integration specification; and
and where said third event content is available as input.

14. The method of claim 1, where said production characteristics are selected by a user through the use of a human interface device.

15. The method of claim 3, where said production characteristics are selected by a user through the use of a human interface device.

16. The method of claim 1, the method comprising the step of: providing an algorithm which comprises determination of the temporal position, temporal duration, temporal rate, or temporal direction of the simulation, and further comprise the production of a production collection implementing said determination.

17. The method of claim 1, further comprising the step of: providing an algorithm which comprises determination of a sequence of one or more rendering operations, and further comprise the production of a production collection implementing said determination.

18. The method of claim 17, where some or all of the rendering frustum is determined for each said rendering operation.

19. The method of claim 1, where said algorithm comprises determination of a rendering model for a virtual world object for a rendering operation, such that said rendering model represents said virtual world object in said rendering.

20. The method of claim 1, where said production characteristic comprises the first determination of a segment of the event depiction of said narrative event;
such that said segment is comprised of a simulation and a sequence of a plurality of renderings;
and such that said simulation is a for a single virtual world clock time span of said narrative event wherein the simulation progresses temporally sequentially from one bound of said virtual world clock time span to the other bound of virtual world clock time span;
and such that the difference between the rendering frustum of each first rendering of said sequence of renderings and the rendering frustum of the successive rendering, if any, is substantially similar to said difference from renderings adjacent to said first rendering;
providing an algorithm that comprises one or both of a second determination of the temporal position, temporal duration, temporal rate, or temporal direction of said simulation and the production of a production collection implementing said second determination; and
providing a third determination of the rendering operations for said sequence of renderings and the production of a production collection implementing said third determination.

21. The method of claim 1 wherein the production characteristic comprises the determination of a rendering target for a sequence of renderings by a renderer such that said rendering target is the one or more representations of a corresponding one or more virtual world objects rendered by said renderer:
and such that each said representation is substantially or entirely contained within each said rendering; and
wherein the algorithm comprises the determination of said one or more virtual world objects.

22. The method of claim 21, where said production characteristic further comprises a constraint on the duration of the sequence of said segments in the event depiction of said narrative event; and
and where said algorithm further comprises the determination of said sequence such that said duration is within said constraint.

23. The method of claim 1, wherein the production characteristic comprises the determination of the language of each of one or more communications of the event depiction of said narrative event; and
the algorithm comprises the determination of a presentation criterion production collection and a presentation criterion integration specification which implements each said language in each corresponding said communication, such that for each communication and for a corresponding one or more renderings from said event depiction of said communication, the representation of said communication in said renderings is expressed in said language.

24. The method of claim 23, where one or more of said communications comprises the communication of a character of said narrative event, or where one or more of said communications comprise the communication of a narrator of said narrative event,
or where at least one of said communications is in the form of written words.

25. The method of claim 1, the method further comprising: the production characteristic which determines each of one or more narrations of the event depiction of said narrative event;
the algorithm comprises the determination of each said narration by selection of a narrative form from a group of narrative forms which correspond to a production characteristic;
translating a narration not already in the form of a production collection whereby the narrations produce a presentation criterion production collection presentation which implements the narrations.

26. The method of claim 1, wherein the production characteristic comprises the determination of a musical accompaniment for each segment of the event depiction of the narrative event.

27. The method of claim 1, the method further comprising the step of: determination of an event depiction conforming to a suitability rating, such that said suitability rating specifies a measure of suitability of a depiction for a certain audience.

28. The method of claim 27, where the suitability rating is based on the age of a member of the audience of said depiction and wherein the suitability rating is based on a measure of the amount within said depiction of one or more of sexual content, violent content, profanity, or drug or alcohol abuse.
